(19) United States
(12) Patent Application Publication
(10) Pub. No.: US 2017/0063927 A1
(43) Pub. Date: Mar. 2, 2017

(54) User-Aware Datacenter Security Policies

(71) Applicant: Microsoft Technology Licensing, LLC, Redmond, WA (US)

(72) Inventors: Benjamin M. Schultz, Bellevue, WA (US); Poornananda R. Gaddehosur, Redmond, WA (US); Mohit Garg, Redmond, WA (US); Jasdeep S. Rajwan, Abbotsford (CA)

(21) Appl. No.: 14/839,829

(22) Filed: Aug. 28, 2015

(51) Int. Cl. H04L 29/06

(52) U.S. Cl. CPC H04L 63/20; H04L 63/08; H04L 63/029

(57) ABSTRACT

A control and monitoring node receives information from a user tracking system indicating a current association between a user identifier of an authenticated user and a device identifier of a client device associated with the authenticated user. The control and monitoring node accesses a user-specific security policy that is associated with the user identifier and that indicates at least a network destination and a user-specific security-related action associated with the network destination. The control and monitoring node generates an active security policy based at least on the user-specific security policy and the information indicating the current association between the user identifier and the device identifier, and provides the active security policy to a network node, such as a firewall or application server.

### BACKGROUND

A trend in datacenter environments is the use of multi-user systems such as terminal services, which share operating system instances. Another trend in datacenter environments is the virtualization of networking appliances, in which network functions such as firewalls are implemented as virtual machines executing on a server. Firewalls protect computing systems, applications, and data from malicious or unauthorized attack. The foundation of stateless firewall policies are built on access control lists (ACLs), which typically include five properties of a network packet header: the source Internet Protocol (IP) address, the destination IP address, the IP protocol field, (e.g., the Transmission Control Protocol (TCP) or User Datagram Protocol (UDP) port), the source TCP or UDP port, and the destination TCP or UDP port. Each of these ACLs includes an action (e.g., deny, allow, etc.). In a networked computing environment, applications are protected by the firewall, which may be configured to listen for queries to a specific server on a specific port. For example this application could be a web server waiting for a request to download a webpage on TCP port 80. The firewall examines the source and destination IP addresses, the source and destination port information, and either allows or denies the packet based on that information, according to the ACL.

Network functions virtualization (NFV) is a network concept that virtualizes various network functions, implementing them as virtual machines running networking-related software on top of standard servers, switches, and storage. Also, software-defined networking (SDN) is a mechanism in which a control plane interfaces with both SDN applications and SDN datapaths. SDN applications communicate network requirements to the control plane via a Northbound Interface (NBI). SDN datapaths advertise and provide control to its forwarding and data processing capabilities over an SDN Control to Data-Plane Interface (CDPI). SDN effectively defines and controls the decisions over where data is forwarded, separating this intelligence from the underlying systems that physically handle the network traffic. In summary, the SDN applications define the topology, the clients, servers and NVF components are the nodes (“hubs” and “endpoints”) in the topology; the SDN datapaths are the “spokes” that connect everything together.

### BRIEF SUMMARY

This Summary is provided in order to introduce simplified concepts of the present disclosure, which are further described below in the Detailed Description. This summary is not intended to identify essential features of the claimed subject matter, nor is it intended for use in determining the scope of the claimed subject matter.

Examples of the present disclosure provide systems, methods, and apparatuses for dynamically updating security policies based on identification of users associated with client devices that attempt to access a protected node. A network node, such as a firewall, is provided with user-specific policies, or group-specific policies. These policies may include destination addresses and protocol port information and information regarding whether the user or groups of users are permitted or denied access. As a client device connects to the network, a control and monitoring node receives the username or other user-identifying information associated with the user, along with some device identifier associated with the client device. The network node creates or is provided with one or more active security policies or rules that are based on user-specific or user group rules modified to indicate the device identifier associated with the client device. The network node then enforces the active security policies based in part on device identifiers included in the packets as they arrive at the network node.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram that illustrates an example environment for providing user-aware datacenter security policies.

FIG. 2 is a schematic diagram that illustrates an example environment for providing user-aware datacenter security policies in a shared user system scenario.

FIG. 3 is a schematic diagram that illustrates an example environment for providing user-aware datacenter security policies in a network address translation scenario.

FIG. 4 is a schematic diagram that illustrates a virtualized network environment for providing user-aware datacenter security policies.

FIG. 5 is a flow diagram that illustrates an example process for updating security policies based on user state information.

FIG. 6 is a block diagram of an example computing system usable to implement an environment for providing user-aware datacenter security policies.

### DETAILED DESCRIPTION

The present disclosure describes a system to dynamically update security policies based on identification of users associated with client devices that attempt to access a protected node, such as an application server, database server, storage server, or other. In a datacenter, firewalls have evolved into highly distributed systems, and manual distribution of policies may not always be feasible. Even where manual distribution is feasible, multi-user systems such as terminal services share a single operating system instance amongst multiple users, making per-user firewall policy difficult or impossible to implement due to the terminal service sessions appearing as a single IP address for all users. In a firewall using a five-tuple ACL for example, it is difficult for the firewall to distinguish between requests from multiple users accessing the same application from the same terminal server. Also, users increasingly appear to come from varying Internet Protocol (IP) addresses as they move from network to network, and as they access the Internet through edge devices that use Network Address Translation (NAT). In these scenarios, a conventional firewall implementing a five-tuple ACL, for example, cannot apply a per-user policy based on IP addresses, since the user device's IP address can change at any time and multiple users may appear to come from the same IP address.

In examples of the present disclosure, a network node, such as a firewall, is provided with user-specific policies, or group-specific policies. These policies may include destination addresses, protocol information, port information and other relevant information such as information regarding whether the user or groups of users are permitted or denied access. As a client device connects to the network, a user tracking system receives the username or other user-identifying information associated with the user, along with some device identifier associated with the client device. The network node creates or is provided with one or more active security policies or rules that are based on user-specific or user group rules modified to indicate the device identifier associated with the client device. The network node then enforces the active security policies based in part on device identifiers included in the packets as they arrive at the network node.

In an example, a client device provides log-in information including the user's username and IP address to a directory service, such as a Lightweight Directory Active Protocol (LDAP) service. The directory service authenticates the user (or otherwise determines that the user is authenticated) and provides a control and monitoring node with one or more device identifiers of a client device that is presently or currently associated with the authenticated user. The control and monitoring node updates the security policy to indicate the current device identifier. The network node enforces the active security policy based on, for example, the presence of the device identifiers associated with the authenticated user in the data packets that arrive at the network node.

In a particular example, a user-specific policy may be used to create an active security policy that indicates a particular IP address currently of a particular client device that is associated with an authenticated user. The user may be authenticated by a LDAP server. In another example, the user-specific policy may be used to create an active security policy that indicates that a particular IP address and one or more TCP ports (and/or UDP ports) that the client device of the user is configured to utilize for connections associated with the user.

The user tracking system may be any system that tracks users as they access a network, and maintains state information regarding whether the user is or has been authenticated. The user tracking system maintains at least device identifiers for the client device presently associated with the user. Example user tracking systems include a mobile device manager, such as one that may support any one of various mobile device management implementations, such as open mobile alliance (OMA) or other device management standards. Other example user tracking systems include directory services, such as Microsoft® Active Directory® or other LDAP-based distributed directory inventory services. Other examples are possible without departing from the scope of embodiments.

A client device identifier utilized by the user tracking system and the firewalls according to embodiments may be, in various examples, a network address (such as an Internet Protocol version 4 (IPv4) or Internet Protocol version 6 (IPv6) address), a protocol port (e.g., a TCP, UDP port, Stream Control Transmission Protocol (SCTP)), license information (e.g., a terminal service customer access license (TS CAL) token), an upper layer protocol identifier such as Real Time Protocol (RTP) connection identifier, or other information associated with the device of the user. In general, any data usable to distinguish one user from another user, and that is included in a data packet or frame that is transmitted from a client device when communicating with a destination node such as an application node, may be used as the client device identifier. In some embodiments, the client device identifier may be provided in header information, such as in network layer (e.g., IP) headers, transport layer headers (e.g., TCP headers and UDP headers), application layer headers (such as RTP headers, Hypertext transport protocol (HTTP) headers, etc.), and so forth. The client device identifier may also be included in payload data, rather than in header data. In some examples, the client device identifier includes non-address information, such as protocol information such as TCP source or destination port information, UDP source or destination port information, application license information, and so forth. The use of non-address information may enable the firewall to distinguish between two different users that appear to be using the same address. Two or more users may be associated with the same network address because, for example, both users use user devices that are situated behind a NAT-enabled appliance, both users use user devices that are connected to the same shared user system (such as a terminal server), or for other reasons.

In some examples, a tunneling protocol is used in order to provide a unique network address, such as an IP address, to the end-user device that can then be used to distinguish users, even those that are behind the same NAT device and therefore are using the same public IP address. One such tunneling protocol may be Teredo Tunneling, such as is described in the Internet Engineering Task Force (IETF) Request For Comments (RFC) 4380. In examples of the present disclosure that use Teredo tunneling, the client device may be a Teredo client, which connects to a Teredo relay. Teredo tunneling is usable through most NAT services. Other tunneling protocols may be used in various embodiments. A tunneling arrangement according to examples of the present disclosure provides the user's device with a unique network address and/or protocol port information even where the user's client device accesses the network via a NAT service. The unique network address (which may be an IPv4, IPv6 address, or other network address) is then be provided to the user tracking service, and ultimately used to dynamically update the active security policies.

Similarly, a Virtual Private Network (VPN) may be used, with the end-user device accessing a VPN server. The VPN server may assign a unique IP address and/or range of port numbers to the end-user device, which can then be provided to the user tracking service, and ultimately used to dynamically update firewall policies. A user device may access the network via a network situated behind a NAT service (and thus may share a public IP address with other devices); in this situation the end-user device may be provided with a unique network address and/or protocol port information by the VPN service.

As used herein, the term “client device” is used to describe a device or system from which a user attempts to connect to a network destination, such as an application server, web server, etc, and whose client device identifier is determinable by a network node—such as a firewall—inspecting packets that originate from the client device. In some embodiments, the client device may be a “user device,” or the device that the user is physically interacting with, such as a laptop computer, desktop computer, netbook, mobile device (such as tablet computer, mobile phone, media player, etc.), game console, kiosk computer, and so forth. In some embodiments, the client device may be a shared user system, such as a terminal server, a remote desktop server, and so forth. In some embodiments, the client device may be an application on a server or virtual machine that is querying another server for information. In this arrangement, the client device is not the same device with which the user interacts (e.g., the client device is not always the same device as the user device). Instead, the user in these arrangements interacts with their user device, which displays a terminal view of a desktop or application provided by the client device.

By providing a mechanism to dynamically provide user-specific rules to a network node such as a firewall, examples of the present disclosure enable increased security. By authenticating the user and correlating the client device identifiers with the user, the security policy can be updated to reflect a user-specific policy or rule with less risk that an unauthorized user is accessing the system. Without the dynamic active security policies provided by examples of the present disclosure, it would not be possible, or at least very difficult, to provide highly granular user-specific security rules for users who, in various examples, utilize various devices to access the system, who access the system from different networks on mobile devices, who utilize shared user systems such as terminal services, and who access the system from networks that provide network address translation. Examples also provide improved scalability and configurability in a datacenter environment. Virtualized firewalls and other virtualized network node types may be instantiated automatically to address demand and/or network failure, with user-specific rules dynamically applied the active security policies based at least in part on real-time or near real-time information of associations between authenticated users and client devices. Use of dynamically updated stateless security policies allows the system to scale easily.

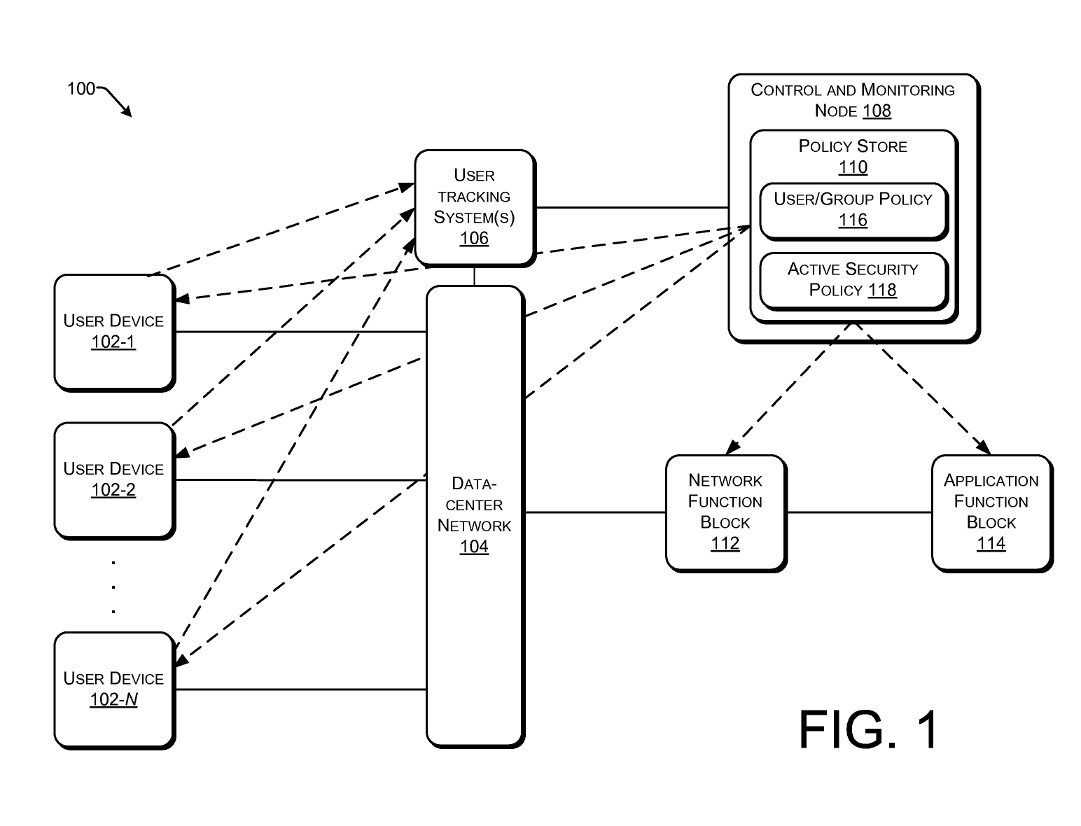

FIG. 1 is a schematic diagram that illustrates an example environment 100 for providing user-aware datacenter security policies. One or more user devices 102 connect to a datacenter network 104. The one or more user devices 102 include, in various examples, computing devices such as personal computers, laptop computers, mobile devices (such as tablet computers, e-readers, mobile phones, etc.), game consoles, kiosk devices, media players, Internet of Things (IoT) appliances (such as smart thermostats, home security systems, and so on), wearables, as well as other devices. The one or more user devices 102 may also include one or more server computing systems. The datacenter network 104 includes, for example, physical infrastructure such as wiring, hubs, interconnects, routers, switches, etc., and may conceptually include in some examples virtual network appliances such as are described elsewhere within this Detailed Description. The user devices 102 may access the datacenter network 104 through one or more different private or public networks, including via the public Internet.

The user devices 102 attempt to communicate with and/or authenticate to one or more user tracking system(s) 106. The user tracking system(s) 106 may include, as noted elsewhere within this Detailed Description, a mobile device management system, a directory service (such as Microsoft® Active Directory®, other LDAP-based distributed directory inventory services, or other directory service). In general, the user tracking system(s) 106 maintain a stateful account of associations between user identifiers of authenticated users and one or more client device identifiers of client devices associated with the authenticated users. More than one user tracking system 106, such as multiple user tracking systems of different types (such as an LDAP-based directory and a mobile device management system) may be used.

In the example illustrated in FIG. 1, the user devices 102 may be the “client devices.” The user devices 102 may authenticate based on some authentication credentials, such as usernames, passwords, personal identification numbers (PINs), biometric information, smart cards, or other information that identifies a particular user. The user identifier may indicate a username, a key associated with the user, biometric information of the user. The user identifier may include hash information (such as a hashed username, key, biometric), and so forth. Any data usable to distinguish one user from another may be used as the user identifier.

The client device identifier is information usable to distinguish one client device from another, either alone or in combination with other data, and that is included in a data packet or frame that arrives at a network node that inspects packets, such as a firewall. In some embodiments, the device identifier may be found in header information, such as in network layer (e.g., IP) headers, transport layer headers (e.g., TCP headers and UDP headers), application layer headers (such as RTP headers, Hypertext transport protocol (HTTP) headers, etc.), and so forth. Based on determining that the user is successfully authenticated or otherwise identified, the one or more user tracking system(s) 106 provide to a control and monitoring node 108 information indicating the user identifier, the client device identifier, and information indicating that there is presently a validated association between the user identifier and the client device identifier.

The control and monitoring node 108 stores or has access to a policy store 110, which includes networking policies for a plurality of devices within the datacenter environment, including for one or more network function blocks, such as the network function block 112, and one or more application function blocks including the application function block 114. The policy store 110 may be part of the control and monitoring node 108 or in a separate, possibly distributed, storage location.

The network function block 112 may include a networking appliance, such as a firewall, an anti-virus appliance, a network router, network switch, a load-balancer, and so forth. The networking appliance may be a conventional network appliance or a virtualized or software-defined network appliance. In a particular example, a networking appliance of the network function block 112 may be instantiated on one or more virtual machines, application containers, virtual machine clusters, such as by virtualization technology, such as but not limited to a hypervisor, a virtual machine monitor (VMM), a cluster manager, and so forth. In a particular set of examples, the network function block 112 includes a firewall, either a conventional firewall implemented as a stand-alone firewall appliance, or a virtualized firewall instantiated by a virtualization technology. However, other types of network function blocks 112 may be used without departing from the scope of the present disclosure. Any type of networking function that is configured to implement security-related functions, such as an ACL, may be included in the network function block 112. In various examples, a network function block may include a router, a VPN server, a network switch, proxy server, NAT server, etc., which may be conventional or virtualized, and which may be configured to implement an ACL or other security-related function.

Similarly, the application function block 114 may be a conventional server implementing an application. The application function block 114 may in some embodiments include a virtualized application, instantiated by virtualization technology within a server, such as but not limited to a virtual machine, an application container, a virtual machine cluster such as may be implemented by a hypervisor, a virtual machine monitor, a cluster manager, and so forth. The application function block 114 may, in some examples, also be configured to enforce a security policy, such as an ACL or other type of policy.

The policy store 110 may include one or more user and/or group policies 116. These policies include security rules that are specific to particular users and/or for particular groups of users. In a particular example, the user/group policy 116 indicates the user or group to which the policy pertains, such as by a username, group name, or other user or group identifier. The user/group policy 116 also indicates networking related rules, such as a destination addresses, protocol information, and so forth to which the user or group is permitted to access and/or to which the user or group is denied access. An example user/group policy 116 is illustrated in Table 1 below.

TABLE 1

| | | | | | Desti- | |
|---|---|---|---|---|---|---|
| | | | Source | | nation | |
| | Pro- | | Protocol | Desti- | Protocol | |
| User- | tocol | Source | Infor- | nation | Infor- | Ac- |
| name | ID | Address | mation | Address | mation | tion |
| User1 | TCP | [dynamically | [dynamically | 2.2.2.2 | 80 | Per- |
| | | defined] | defined] | | | mit |
| Group2 | TCP | [dynamically | 17000 | 2.2.2.2 | 80 | Per- |
| | | defined] | through | | | mit |
| | | | 17500 | | | |
| . . . | | . . . | . . . | . . . | . . . | . . . |
| UserN | TCP | 1.1.1.1 | * | 2.2.2.2 | 80 | Per- |
| | | | | | | mit |

In the example user/group policy 116 illustrated above, User1 (who may be associated with user device 102-1) is permitted to access destination 2.2.2.2 (which may in this example be the address of the application function block 114) on TCP port 80 from a dynamically defined source address and TCP port. Dynamically defined in this example indicates that policy is to be updated with the source address and source protocol information provided by the one or more user tracking system(s) 106 upon authentication of User1 accessing a client device. Group2 (a group of users, one of whom may be associated with user device 102-2) is permitted to access destination 2.2.2.2 on port 80, from a dynamically defined source address and a specific range of TCP ports. UserN (who may be associated with user device 102-N) is permitted access to destination address 2.2.2.2, as long as its source address is 1.1.1.1. The source address and protocol information is not dynamically defined for UserN. In this example, the source protocol information for UserN is a wildcard, indicating that any source protocol information is acceptable for permitting UserN to access destination 2.2.2.2. Other example user/group policies 116 are possible without departing from the scope of the present disclosure. For example, rather than a range of ports (such as is defined for User 2), a list of one or more non-contiguous ports or groups of ports may be specified. Also, other protocol information besides TCP, such as UDP, SCTP, may be indicated in the user/group policy 116 without departing from the scope of embodiments. IPv6 addresses may be specified instead of IPv4 addresses, as well as other types of addresses, such as Media Access Control (MAC) addresses, may be utilized without departing from the scope of the present disclosure.

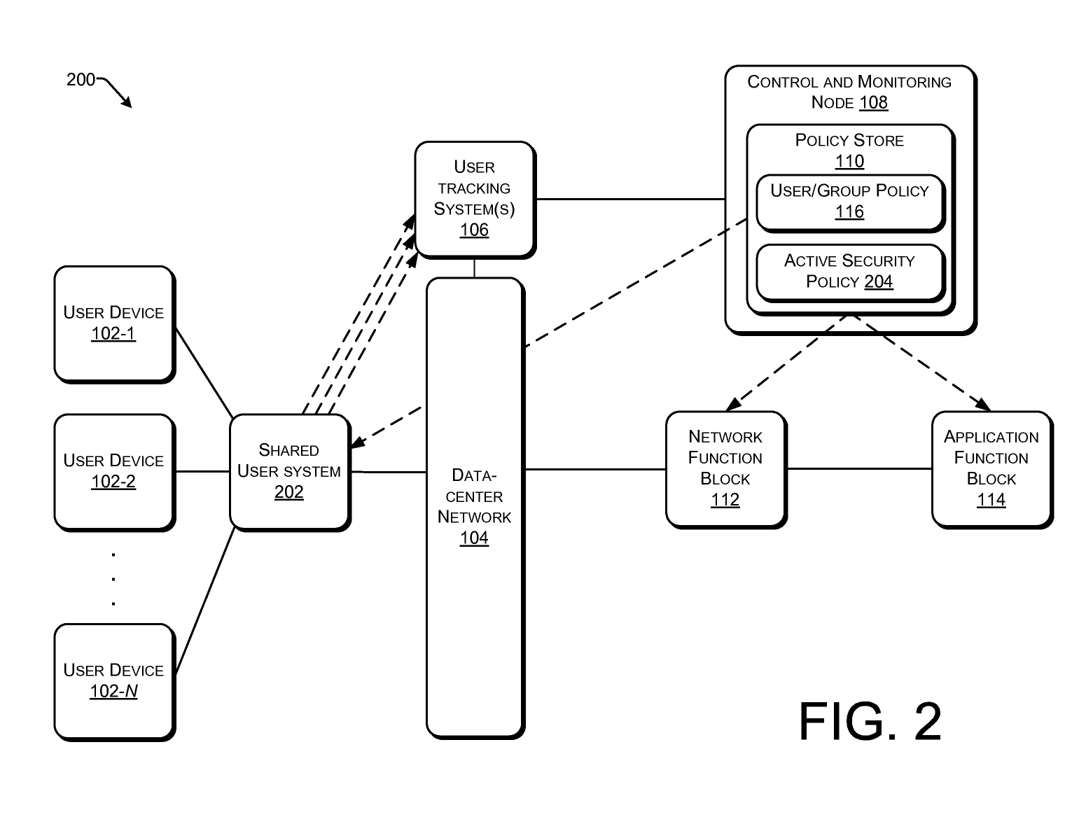

The source protocol information may be provided as a policy by the control and monitoring node 108 to the user devices 102 (shown by dashed lines coupling the policy store 110 to the user devices 102 in FIG. 2), by the one or more user tracking system(s) 106, by manual configuration of the shared user system, or by some other mechanism. Thus, the user devices 102 are configured, in at least some examples, to assign the source address and/or the source protocol information on a per-user basis for any outbound connections associated with the user that match the destination address and/or the destination port information of the user/group policy 116, and possibly for other outbound connections as well. Other examples are possible without departing from the scope of the present disclosure.

The policy store 110 includes an active security policy 118, which may be based at least in part on the user/group policy 116 and the user and device information provided by the one or more user tracking system(s) 106. For example, where the one or more user tracking system(s) 106 receives information indicating that User1 is at network address 1.1.1.10, and is assigned or otherwise configured to utilize source TCP ports 10000-11000, an active security policy 118 may be generated based at least in part to reflect this information. This example is shown in Table 2 below.

TABLE 2

| | | | | | Desti- | |
|---|---|---|---|---|---|---|
| | | | Source | | nation | |
| | Pro- | | Protocol | Desti- | Protocol | |
| User- | tocol | Source | Infor- | nation | Infor- | Ac- |
| name | ID | Address | mation | Address | mation | tion |
| User1 | TCP | 1.1.1.10 | TCP 10000- | 2.2.2.2 | 80 | Per- |
| | | | 11000 | | | mit |

The example active security policy 118 is generated based on the device identifiers provided by the one or more user tracking system(s) 106 (e.g., the source address and source protocol information) and from the user/group policy 116. Thus, the destination address and destination protocol information may be derived from the user/group policy 116 and the source address and source protocol information is derived from the device identifiers provided by the one or more user tracking system(s) 106. By first authenticating the user, and associating the authenticated user with the device identifier of the client device of the user, the active security policy 118 is able to apply a user-specific security policy, which is more secure than a generic security policy that applies to all users.

Where multiple user tracking systems 106 are used, the control and monitoring node 108 may synthesize the active security policy 118 based which of the user tracking systems 106 provides information regarding the authenticated user devices 102. Where multiple ones of the user tracking systems 106 provide information regarding a particular authenticated user device 102 to the control and monitoring node 108 (e.g., within a similar time frame), the control and monitoring node 108 is configured to synthesize the active security policy 118 for the user associated with the particular user device 102 based on input from all user tracking systems 106 that provide information regarding the particular user device 102. For example, some user tracking systems 106 may track location (and may not authenticate the user device 102). Such user tracking systems 106 may provide the user device 102 location—such as based on network address, global positioning system (GPS) coordinates, mobile network location data (such as may be based on base station connections to the mobile network, etc.).

In other examples, a first user tracking system 106 may authenticate the user device 102, using a certain level of security or trustworthiness (such as based on username and password) while a second user tracking system 106 authenticates the user device 102 using a different level of security or trustworthiness (such as based on biometric data, location data, smart card authentication, and so forth). Based on the level of authentication security, the control and monitoring node 108 may produce the active security policy 118. In another example, a user tracking system 106 may provide information to the control and monitoring node 108 regarding a level of access provided or afforded to the user device 102 based on a confidence level in the identity of the user. The control and monitoring node 108 may utilize this information to generate the active security policy 118, such as by providing access to more or fewer application servers, allowing access to or from different destination and source protocol ports, and so forth.

Furthermore, the network node 112 (and/or the application node 114) may be configured to track usage statistics. The network node 112 and/or the application node 114 may provide such usage statistics to the control and monitoring node 108, which utilizes the usage statistics to determine a level of access to be provided to the user device 102. For example, where the usage data (such as statistics, usage patterns, and so on) indicate suspicious activities, the level of access provided to the user may be reduced in a modified active security policy 118 provided to the network node 112 and/or the application node 114.

In one specific example, a European executive travels in America. A first user tracking system 106 tracks the identity of the European executive based on the executive's user device 102. A second user tracking system 106 tracks where the European executive is located base on the location of the executive's user device 102. The control and monitoring node 108 synthesizes the location and identify information from two different user tracking systems 106 so that the security policy 118 enables the user to access their email, but not servers that contain sensitive data that would violate European privacy laws and/or company policy were the executive allowed to access the data outside of Europe.

In another specific example, a sales associate from a corporation travels to a place where data compromises are common. A first user tracking system 106 tracks the identity of the sales associate based on his or her user device 102. A second user tracking system 106 tracks the sales associate's location based on the location of their user device 102. The control and monitoring node 108 synthesizes this information so they have access to sales materials, but not to sensitive company data. Other examples are possible without departing from the scope of embodiments.

The active security policy 118 may be provided by the control and monitoring node 108 to one or more network function blocks in the environment 100, including the network function block 112. Providing the active security policy 118 may include providing configuration data for the network function block 112. The active security policy 118 may be provided by the control and monitoring node 108 to the application function block 114 in addition to or instead of providing it to one or more network function blocks. Although the example active security policy 118 shown above includes username User1, in various examples the user identifier may not be present in the active security policy 118, as the network function block 112 and/or the application function block 114 that enforces the active security policy 118 may permit or deny packets based on the device identifiers (e.g., the address and protocol information) included in the packets that it receives, and may not determine a user identifier from the packets that it receives or otherwise enforce the active security policy 118 based on user identifiers present in the data packets that arrive at the network function block 112 and/or the application function block 114.

In other examples of the present disclosure, the user/group policies 116 and the user association information are provided to the network function block 112 and/or the application function block 114. In that instance, the network function block 112 and/or the application function block 114 may dynamically generate the active security policy 118 from the user/group policies.

Data packets from the user devices 102 are received by the network function block 112 and/or the application function block 114. The network function block 112 and/or the application function block 114 enforces the active security policies 118. This includes inspecting the packets, such as by inspecting one or more headers of the incoming packets, matching the device identifier information included therein with the active security policy 118, and either allowing or denying the packet to be forwarded to the application function block (such as where the active security policy is enforced by the network function block 112) or accepting or discarding the packets (such as where the active security policy 118 is enforced by the application function block 114).

The active security policy 118 example shown above includes inbound security policies for packets received from the external environment (e.g., from user devices 102). The active security policy 118 may also include outbound policy information, including rules for allowing or denying packets to be sent to the external environment, including the user devices 102. Such inbound active security policies may also be generated based on the device identifiers associated with the authenticated user, such as by including the device identifiers in the destination address and destination protocol portions of the outbound security policy. Also, the network function block 112 may enforce the active security policy 118 in either a stateful or a stateless manner. In a stateful enforcement, connection state information may be maintained, such that packets are permitted to be forwarded when the packets conform to the known state of a connection between the user devices 102 and the application function block 114, and as long as such packets otherwise conform to the active security policy 118. For example a reply packet is not permitted to be transmitted if a request packet is not first received. In a stateless enforcement, such connection state information is not maintained, and the packets are permitted to pass as long as they conform to the active security policy 118. All packets that do not specifically match a rule in the active security policy 118 may be dropped as a default.

FIG. 2 is a schematic diagram that illustrates an example environment 200 for providing user-aware datacenter security policies in a shared user system scenario. A shared user system 202 is present in the environment 200. The shared user system 202 may provide a terminal service or other remote desktop service. In these types of systems, multiple user devices 102 are able to access an operating system environment, application, and/or a remote desktop environment provided by the shared user system 202 through a network connection. The user devices 102 are configured to display desktop and application views on display devices of the user devices 102, thereby providing a “terminal” session to the shared user system 202. Connections to the application function block 114 by the user devices 102 through the shared user system 202 would appear to come from a single IP address (or other network address type). This is because the user devices 102 may all share an IP address provided by or assigned to the shared user system 202. Thus, in the examples illustrated in FIG. 2, the shared user system 202 is a “client device,” which is shared amongst the user devices 102.

As the users log into or otherwise connect to the shared user system 202, the user tracking system(s) 106 receives the usernames or other user identifiers associated with the user devices 102 as well as device identifiers. These device identifiers may include a shared IP address, as well as other protocol information associated with the connections between the shared user system 202 and the user devices 102. The client software executing on the shared user system 202 may communicate with the user tracking system(s) 106 to provide the client device identifier information.

As with the examples illustrated in FIG. 1, the user identifiers and the associated device identifiers are provide to the control and monitoring node 108. The control and monitoring node 108 utilizes this information to update the active security policy 204. An example of the active security policy 204 is shown in Table 3 below for two users.

TABLE 3

| | | | Source | | Source | |
|---|---|---|---|---|---|---|
| | Pro- | | Protocol | Desti- | Protocol | |
| User- | tocol | Source | Infor- | nation | Infor- | Ac- |
| name | ID | Address | mation | Address | mation | tion |
| User1 | TCP | 1.1.1.12 | TCP 10000 | 2.2.2.2 | 80 | Per- |
| | | | | | | mit |
| User2 | TCP | 1.1.1.12 | TCP 11000 | 2.2.2.2 | 80 | Per- |
| | | | | | | mit |

In the example active security policy 204 illustrated above, User1 (which may be associated with user device 102-1) and User 2 (which may be associated with user device 102-2) are both currently at 1.1.1.12 (which in this example may be the IP address associated with the shared user system 202). Both User1 and User2 have been authenticated. However, the user tracking system(s) 106 determines that the service provided to User1 by the shared user system 202 has been assigned or is otherwise configured to utilize TCP port 10000, while the service provided to User2 by the shared user system 202 has been assigned or otherwise configured to utilize TCP port 11000. These TCP ports may be assigned by the shared user system 202, selected by the user devices 102, assigned by the user tracking system(s) 106, provided in the user-specific policy and assigned by the control and monitoring node 108 to the or assigned by some other mechanism.

The source protocol information may be provided as a policy by the control and monitoring node 108 to the shared user system 202 (shown by dashed line coupling the user/group policy 116 to the shared user system 202 in FIG. 2), by the user tracking system(s) 106, by manual configuration of the shared user system, or by some other mechanism. Thus, the shared user system 202 is configured, in at least some examples, to assign the source address and/or the source protocol information on a per-user basis for any outbound connections associated with the user that match the destination address and/or the destination port information of the user/group policy 116, and possibly for other outbound connections as well. Other examples are possible without departing from the scope of the present disclosure.

The active security policy 204 may be pushed to the network function block 112. Similarly, the active security policy 204 may be pushed to the application function block 114. The network function block 112 and/or the application function block 114 enforces the active security policy 204, such as was described above with respect to FIG. 1, including both stateful and stateless enforcement. Connection attempts by the user devices 102 through the shared user system 202 to the application function block 114 utilize the assigned protocol information, such as the assigned source TCP ports shown in the example active security policy 204 shown above.

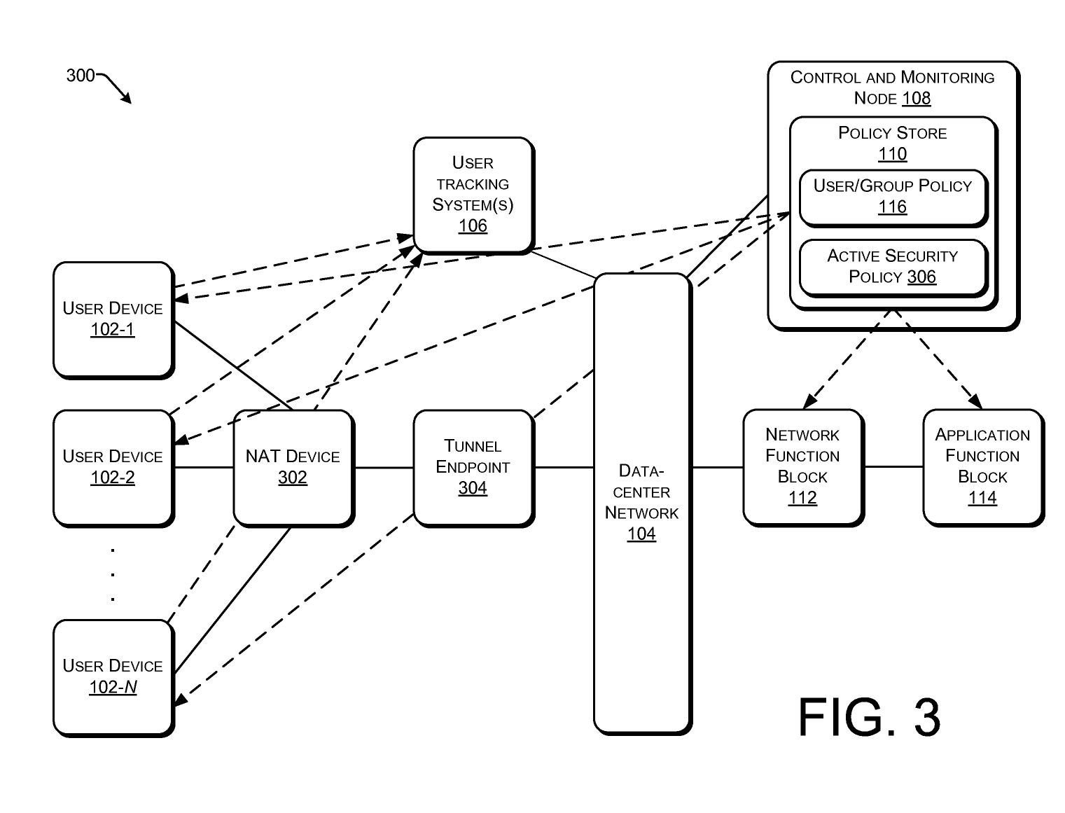

FIG. 3 is a schematic diagram that illustrates an example environment 300 for providing user-aware datacenter security policies in a network address translation scenario. In the environment 300, the user devices 102 access the datacenter environment via a NAT device 302. A NAT device 302 may be, in various embodiments, a router, a firewall, a proxy server, a standalone NAT appliance, or other device type. In a typical NAT scenario, the user devices 102 are assigned a “private” network address, such as from the private IPv4 address space identified in IETF RFC 1918 and from the private IPv6 address space identified in RFC 4193. The NAT device 302 may translate the internal, private addresses assigned to the user devices 102 to one or more public IP addresses. Thus, in at least some instances, the user devices 102 behind the NAT device 302 may appear to come from the same public IP address.

The user devices 102 may be configured to implement a tunnel using a tunneling protocol to a tunnel endpoint 304. The tunneling protocol encapsulates IP packets having a network address, such as a public IP address, recognized by the tunnel endpoint 304. Such encapsulated IP packets may be “payload” information to an outer IP packet that is subjected to the NAT service by the NAT device 302. Each user device 102 that tunnels to the tunnel endpoint 304 may be given a unique IP address for its tunnel by the tunnel endpoint 304. The outer IP packet's IP address may be translated or changed by the NAT device, but the inner IP address of the encapsulated IP packets remains unchanged. The user device 102 is configured to provide its inner IP address to the user tracking system(s) 106, along with other protocol information. Thus, the user tracking system(s) 106 receives user identifiers from the user devices 102, plus their unique inner IP addresses and any port information, rather than the private IP addresses or their shared NAT-provided public IP address. The user tracking system(s) 106 updates the control and monitoring node 108 with the user identifier information and the device identifier information received. The control and monitoring node 108 updates an active security policy 306, such as shown in Table 4 below.

TABLE 4

| | | | Source | | Source | |
|---|---|---|---|---|---|---|
| | Pro- | | Protocol | Desti- | Protocol | |
| User- | tocol | Source | Infor- | nation | Infor- | Ac- |
| name | ID | Address | mation | Address | mation | tion |
| User1 | TCP | 1.1.1.10 | * | 2.2.2.2 | 80 | Per- |
| | | | | | | mit |
| User2 | TCP | 1.1.1.12 | * | 2.2.2.2 | 80 | Per- |
| | | | | | | mit |

In the example active security policy 306 illustrated above, User1 (which may be associated with user device 102-1) and User 2 (which may be associated with user device 102-2) are identified by source IP addresses 1.1.1.10 and 1.1.1.12, respectively. These IP addresses are the tunnel IP addresses (such as inner IP addresses) associated with the tunnels to the tunnel endpoint 304. The source protocol information is shown in the example active security policy 306 illustrated above as being a wildcard. This may be possible where all user devices 102 tunneling to the tunnel endpoint 304 are assigned unique tunnel network addresses. However, the user tracking system(s) 106 may in some examples receive information that users are assigned one or more source protocol information identifiers, such as TCP ports, UDP ports, application tokens, and so forth, similar to or the same as in the active security policy 204 discussed above in association to FIG. 2.

Similar to the arrangement describe above with respect to FIG. 1, the source protocol information may be provided as a policy by the control and monitoring node 108 to the user devices 102 (shown by dashed lines coupling the policy store 110 to the user devices 102 in FIG. 2), by the user tracking system(s) 106, by manual configuration of the shared user system, or by some other mechanism. Thus, the user devices 102 are configured, in at least some examples, to assign the source address and/or the source protocol information on a per-user basis for any outbound connections associated with the user that match the destination address and/or the destination port information of the user/group policy 116, and possibly for other outbound connections as well.

In some embodiments, a tunneling protocol that is compatible with NAT may be used. One example of such a tunneling protocol is Teredo tunneling, which in some implementations provides an IPv6 address to a user device 102 that is assigned an IPv4 address, such as a private IPv4 address. Thus, in an example active security policy 306, the user devices 102 may be assigned IPv6 tunnel addresses, rather than IPv4 tunnel addresses as illustrated in the table above.

Other examples are possible without departing from the scope of the present disclosure. For example, the tunnel endpoint 304 may be configured to assign some or all of the source address and/or the source protocol information on a per-user basis for any outbound connections associated with the user that match the destination address and/or the destination port information of the user/group policy 116, and possibly for other outbound connections.

For another example, a tunnel endpoint 304 may be a virtual private network (VPN) server, in which tunneling and/or encryption is utilized to provide a private network connection to the datacenter environment over a public network such as the Internet. In some implementations of a VPN, all user devices 102 connected to the VPN server may share or otherwise appear to utilize the same IP address. Other types of tunnel endpoints 304 without departing from the scope of the present disclosure.

The active security policy 306 may be pushed to the network function block 112. Similarly, the active security policy 306 may be pushed to the application function block 114. The network function block 112 and/or the application function block 114 enforces the active security policy 306, such as was described above with respect to FIG. 1, including either stateful or stateless enforcement.

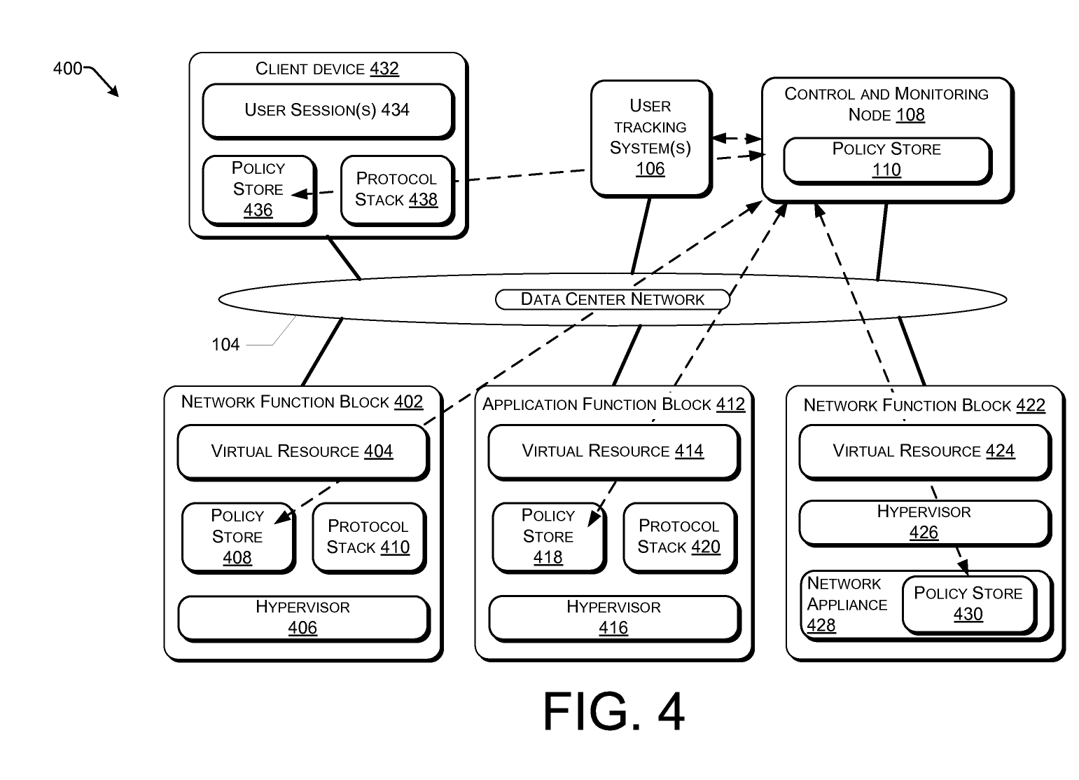

FIG. 4 is a schematic diagram that illustrates a virtualized network environment 400 for providing user-aware datacenter security policies. The environment 400 includes one or more network function blocks 402, which may be the same as or similar to the network function block 112. The network function block 402 includes one or more virtual resources 404, which may include a virtual machine implemented by a virtualization technology such as a hypervisor 406. The virtual resource 404 may be configured to provide one more virtualized network appliance functions, such as a router function, a switch function, a firewall function, an anti-virus function, a proxy server function, a VPN function, a load balancing function, and so forth. The network function block 402 includes a policy store 408 that may include one or more active security policies provided by the control and monitoring node 108. The policy store 408 is updated to include active security policies, and the virtual resource 404 in conjunction with the protocol stack 410 is configured to enforce the policies in the policy store 408, including any active security policies.

Environment 400 includes one or more application function blocks 412, which may be the same as or similar to the application function block 114. The application function block 412 includes one or more virtual resources 414, executable using a virtualization technology such as a virtual machine using a virtualization technology such as a hypervisor 416. The virtual resource 414 may be configured to provide one more virtualized applications, such as a web server, database, email server, search engine, productivity applications, and so forth. The application function block 412 includes a policy store 418 that may include one or more active security policies provided by the control and monitoring node 108. The policy store 418 is updated to include active security policies, and the virtual resource 414 in conjunction with the protocol stack 420 is configured to enforce the policies in the policy store 418, including any active security policies.

Environment 400 includes network function block 422, which may be the same as or similar to the network function block 112 as shown in FIG. 1. The network function block 422 may include one or more virtual resources 424, executable using a virtualization technology such as a virtual machine using a virtualization technology such as a hypervisor 426. The virtual resource 424 may be configured to provide one more virtualized network appliance functions, such as a router function, a switch function, a firewall function, a anti-virus function, a proxy server function, a VPN function, a load balancing function, and so forth. The network function block 422 includes a network appliance 428, which may be a conventional standalone network appliance, rather than a virtualized appliance, such as the virtual resource 404. The network appliance 428 may be a firewall, router, proxy server, switch, or other network appliance type. The one or more active security policies provided by the control and monitoring node 108 may be stored in policy store 430. The policy store 430 is updated to include active security policies, and the network appliance 428 is configured to enforce the policies in the policy store 408, including any active security policies. In some examples, the network function block 422 may be provided without the virtual resource 424 and the hypervisor 426. Thus, in some examples, the network function block 422 represents a standalone network appliance 428, such as a legacy or conventional network router, firewall, anti-virus monitor, proxy server, VPN server, load balancer, etc.

The control and monitoring node 108 is configured in some examples to monitor the environment 400 and instantiate or deactivate virtual resources on the network function blocks and/or the application function blocks based on various factors such as network utilization, computing resource utilization, failure conditions, and so forth. As new virtual resources are instantiated, or as virtual resources are deactivated, appropriate networking policies are provided (in either push or pull fashion) to the appropriate virtual resources, including any user-aware security policies such as the active security policies 118, 204, and 306. Thus, the appropriate active security policies are applied to the appropriate function blocks in the network, even as new function blocks, including both network function blocks and application function blocks, are instantiated and deactivated in the network.

Environment 400 also includes client device 432, which may be the same as or similar to the user devices 102 and the shared user system 202 as shown in FIGS. 1 and 2 respectively. The client device 432 may include one or more user sessions 434. Where the client device 432 is a shared user system, such as the shared user system 202, the user sessions may include remote desktop services, terminal services, etc. provided to one or more user devices. The user sessions 434 include applications configured to access network nodes, such as the application function block 412 or other network nodes. Upon authentication of the user via the client device 432, the control and monitoring node 108 may provide the client device 432 with a security policy, which is stored by the client device 432 in a policy store 436. The policy may include source address and/or source protocol information to be used for outbound connections. The policy may also include indications of destination address and destination protocol information. The policy provided to the client device 432 may include all or a portion of an active security policy, such as the active security policies 118, 204, and 306. The policy may be configured the client device 432 to utilize the source address and/or source protocol information for outbound connections that match the destination address and/or destination protocol information contained in the policy.

The protocol stack 438 determines from which user sessions 434 outbound connections originate, attempts to match the outbound connection to the policy stored in the policy store (such as based on the destination address and destination protocol information in the outbound connection), and assigns the source address and/or the source protocol information contained within the policy store for the outbound connections. Thus, if a first user is permitted to utilize source TCP port 11000 for an outbound connection to the application function block 114 and a second user is permitted to utilize the source TCP port 12000 for an outbound connection to the application function block 114 (as shown in the example policy table below), then the protocol stack 438 binds the outbound connections for these user sessions and enforces the assigned TCP port numbers for such outbound connections. If a user is not permitted to access the application function block 412, then no outbound connection may be permitted. The policy stored in the policy store 436 may indicate a default source address and/or source protocol information for any outbound connections that do not match a specific rule in the policy. In some embodiments, the policy store 436 may be manually configured with the policy.

TABLE 5

| | | | Source | | Source | |
|---|---|---|---|---|---|---|
| | Pro- | | Protocol | Desti- | Protocol | |
| User- | tocol | Source | Infor- | nation | Infor- | Ac- |
| name | ID | Address | mation | Address | mation | tion |
| User1 | TCP | 1.1.1.10 | 11000 | 2.2.2.2 | 80 | Per- |
| | | | | | | mit |
| User2 | TCP | 1.1.1.12 | 12000 | 2.2.2.2 | 80 | Per- |
| | | | | | | mit |

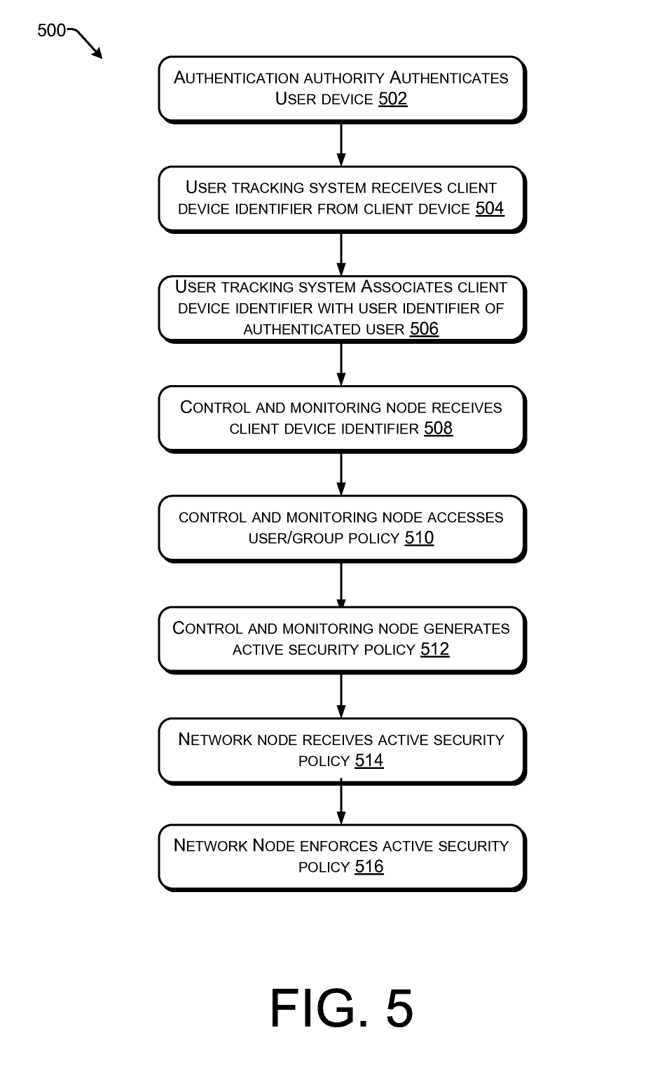

FIG. 5 depicts a flow diagram that shows an example process in accordance with various examples. The operations of this process are illustrated in individual blocks and summarized with reference to those blocks. This process is illustrated as a logical flow graph, each operation of which may represent a set of operations that can be implemented in hardware, software, or a combination thereof. In the context of software, the operations represent computer-executable instructions stored on one or more computer storage media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be combined in any order, separated into sub-operations, and/or performed in parallel to implement the process. Processes according to various examples of the present disclosure may include only some or all of the operations depicted in the logical flow graph.

FIG. 5 illustrates an example process 500 for updating security policies based on user state information. At 502, an authentication authority of some kind, such as a user tracking system(s) 106 authenticates a user via a client device, such as a user device 102 or a shared user system 502. The authentication authority may authenticate client device using authentication credentials provided by the user via a user device and/or a client device, such as one or more of a username and password pair, biometric information, a PIN, a smart card provided authentication credentials, and so forth. Examples of the present disclosure are not limited to any particular type or types of authentication credentials.

At 504, the user tracking system receives a client device identifier of the client device. The client device identifier includes data usable to distinguish one user from another user, and that is included in a data packet or frame that is transmitted from a client device when communicating with a destination node such as an application node. Some specific examples of a client device identifiers include network addresses of the client device (e.g., IP addresses), protocol port numbers assigned to the user device, to the client device, and/or to a session provided to the user by the client device acting as a shared user system. Other examples are possible without departing from the scope of the present disclosure.

At 506, the user tracking system associates a user identifier of the authenticated user (such as a username, although other user identifiers may be used such as a hashed username created using a hashing algorithm or an encrypted username using a private encryption key) with the client device identifiers that are received by the client device. The association occurs in part based on the successful authentication of the user via the client device. By authenticating the user and correlating the client device identifiers with the user, the security policy can be updated to reflect a user-specific policy or rule with less risk that an unauthorized user is accessing the system.

At 508, the user tracking system sends, and a control and monitoring system (such as the control and monitoring system 108) receives information indicating a currently or presently valid association between a user identifier of the authenticated user and a device identifier of the client device associated with the authenticated user. The information indicating the association may be an implicit association. For example, the user tracking system may communicate a message to the control and monitoring system that includes both the user identifier and the client device identifier together, thereby indicating that the two have a currently or presently valid association, and also indicating that the user associated with the user identifier has been authenticated via the client device associated with the client device identifier.

At 510, the control and monitoring node accesses a user-specific security policy that is associated with the user identifier and that indicates at least a network destination and a user-specific security-related action associated with the network destination, such as a security action associated with attempts by the user to access a destination. In some embodiments, the control and monitoring node may proactively access the user-specific security policy. In some embodiments, another system, such as the user tracking system, may proactively push the user-specific policy to the control and monitoring node. The user-specific security-related action may be allow or deny, or some other action. The user-specific policy may also indicate destination protocol information, such as destination TCP or UDP ports, application tokens provided by a shared user system, and so forth.

At 512, the control and monitoring node generates an active security policy based at least on the user-specific security policy and the information indicating the current association between the user identifier and the device identifier. The client device identifier associated with the authenticated user may, in some examples, be a network address of the client device and a range of TCP or UDP ports assigned to the user for use on the client device. The network address and range of TCP or UDP ports may be, in some examples, plugged in as destination address and destination protocol information into the user-specific security policy to generate the active security policy. Other examples are possible without departing from the scope of embodiments. The active security policy includes the security action associated with attempts by the user to access the destination.

At 514, the control and monitoring node sends, and a network node receives, the active security policy. In alternative embodiments, the network node may receive (such as from the user tracking service or the control and monitoring node) the association information discussed above (e.g., the association between the client identifier and the authenticated user) and the network node itself generates the active security policy from this information and from a user-specific security policy. In some examples, the network node may be included as part of a network function block such as the network function blocks 112, 402, and 422. In some examples, the network node may be included in an application function block, such as the application function blocks 114 and 412. In some embodiments, the control and monitoring node may transmit the active security policy (or information usable by the network node to generate the active security policy) responsive to determining that the network node has been instantiate in the network. The control and monitoring node may identify the network node as providing security services to the application node.

At 516, the network node enforces the active security policy. Enforcing the active security policy includes, in various examples, inspecting packets that arrive at the network node, comparing the data found in the packets—such as in the headers in the packets—to the active security policy, identifying any matches between the packets and an entry in the active security policy, and performing the actions specified in the active security policy (e.g., deny, allow, drop, accept). As noted above, enforcement of the active security policy may be stateless or stateful.

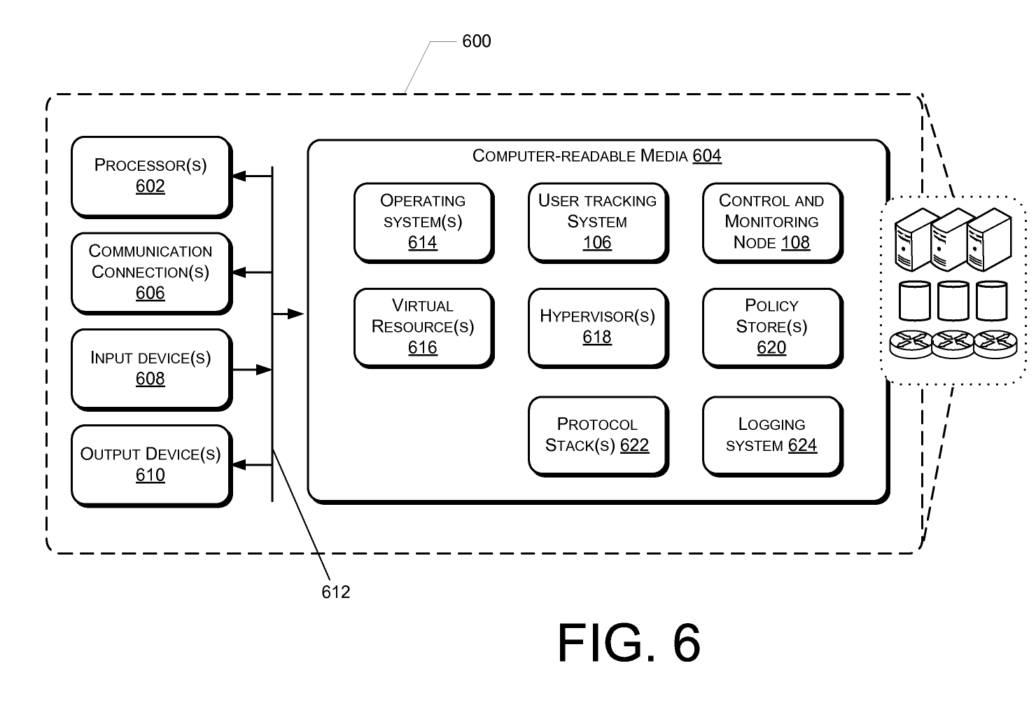

FIG. 6 is a block diagram of an example computing system 600 usable to implement an environment for providing user-aware datacenter security policies. Computing system 600 may be deployed in a shared network environment, including in one or more datacenters, one or more cloud computing environments, or other network containing multiple computing devices. According to various non-limiting examples, the computing system 600 includes one or more devices, such as servers, storage devices, and networking equipment. In one example configuration, the computing system 600 comprises at least one processor 602. The computing system 600 also contains communication connection(s) 606 that allow communications with various other systems. The computing system 600 also includes one or more input devices 608, such as a keyboard, mouse, pen, voice input device, touch input device, etc., and one or more output devices 610, such as a display (including a touch-screen display), speakers, printer, etc. coupled communicatively to the processor(s) 602 and the computer-readable media 604 via connections 612.

Computer-readable media 604 stores computer-executable instructions that are loadable and executable on the processor(s) 602, as well as data generated during execution of, and/or usable in conjunction with, these programs. In the illustrated example, computer-readable media 604 stores operating systems 614, which provide basic system functionality to the user tracking system(s) 106, the control and monitoring node 108, virtual resource(s) 616 (which may be the same as or similar to the virtual resources 404, 414, and 424), the hypervisor(s) 618 (which may be the same as or similar to the hypervisors 406, 416, 426), the policy store(s) 620 (which may be the same as or similar to the policy stores 110, 408, 418, 430, and 436), and the protocol stack(s) 622 (which may be the same as or similar to the protocol stacks 410 and 420). One or more of the operating system instances 614 may be instantiated as virtual machines under one or more hypervisors 618.

The computer-readable media 604 also stores a logging system 624 that tracks updates to the policy stores 620, including moves, migrations, and duplications of virtual resources in the network. The logging system may also track per-user utilization of the network resources, such as based on the client identifiers associated with the users.

Processor(s) 602 may include one or more single-core processing unit(s), multi-core processing unit(s), central processing units (CPUs), graphics processing units (GPUs), general-purpose graphics processing units (GPGPUs), or hardware logic components configured, e.g., via specialized programming from modules or application program interfaces (APIs), to perform functions described herein. In alternative examples one or more functions of the present disclosure may be performed or executed by, and without limitation, hardware logic components including Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Digital Signal Processing unit(s) (DSPs), and other types of customized processing unit(s). For example, a processing unit configured to perform one or more of the functions described herein may represent a hybrid device that includes a CPU core embedded in an FPGA fabric. These or other hardware logic components may operate independently or, in some instances, may be driven by a CPU. In some examples, examples of the computing system 600 may include a plurality of processing units of multiple types. For example, the processing units may be a combination of one or more GPGPUs and one or more FPGAs. Different processing units may have different execution models, e.g., as is the case for graphics processing units (GPUs) and central processing units (CPUs).

Depending on the configuration and type of computing device used, computer-readable media 604 include volatile memory (such as random access memory (RAM)) and/or non-volatile memory (such as read-only memory (ROM), flash memory, etc.). The computer-readable media 604 can also include additional removable storage and/or non-removable storage including, but not limited to, SSD (e.g., flash memory), HDD storage or other type of magnetic storage, optical storage, and/or other storage that can provide non-volatile storage of computer-executable instructions, data structures, program modules, and other data for computing system 600.

Computer-readable media 604 can, for example, represent computer memory, which is a form of computer storage media. Computer-readable media includes at least two types of computer-readable media, namely computer storage media and communications media. Computer storage media includes volatile and non-volatile, removable and non-removable media implemented in any process or technology for storage of information such as computer-executable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other medium that can be used to store information for access and retrieval by a computing device. In contrast, communication media can embody computer-executable instructions, data structures, program modules, or other data in a modulated data signal, such as a carrier wave, or other transmission mechanism. As defined herein, computer storage media does not include communication media.

### EXAMPLE CLAUSES

A. A distributed computing system comprising a plurality of processors, memory; and a plurality of programming instructions stored on the memory and executable by the plurality of processors to implement a user tracking system to authenticate a user accessing one or more networks via a client device and to determine a client device identifier of the client device, a control and monitoring node to: receive information indicating a presently valid association between a user identifier of the user and the client device identifier, and generate an active security policy for the user based at least on the client device identifier and a user-specific security policy that indicates at least a destination node and an action to be applied to attempts by the user to access the destination node. The instructions further executable to implement a firewall to enforce the active security policy by at least inspecting the data packets and identifying from the data packets attempts by the user to access the destination node.

B. The distributed computing system of clause B, wherein the client device identifier indicates at least a network address of a shared user system and protocol port information assigned to a shared user system session provided to the user by the shared user system.

C. The distributed computing system of clause A or B, wherein the plurality of programming instructions are further executable by the plurality of processors to implement a tunnel endpoint service that provides a tunneling service to the client device, and wherein the client device identifier includes at least an inner IP address assigned to the client device and associated with the tunneling service.

D. The distributed computing system of any of clauses A through C, wherein the user tracking system is a lightweight directory access protocol based directory service that authenticates the user associated with the client device, wherein the distributed computing system further comprises another user tracking system that tracks a location of the client device, and the control and monitoring node is further configured to generate the active security policy for the user based at least on the location of the client device.

E. The distributed computing system of any of clauses A through D, wherein the control and monitoring node is configured to provide the active security policy to the network node based at least on determining that the network node has been instantiated.

F. The distributed computing system of any of clauses A through E, further comprising a plurality of user tracking systems, including the user tracking system, and wherein the control and monitoring node is further configured to validate identity of the authenticated user based at least on first input from the plurality of user tracking systems, and further based on second input from the network node indicating usage data of the authenticated user.

G. The distributed computing system of clause F, wherein the control and monitoring node is further configured to determine a level of access to be provided to the authenticated user based at least on the first input from the plurality of user tracking systems, the first input including application node access levels of the authenticated user, and generate the active security policy such that the network node provides the client with the level of access to the destination node.

H. The distributed computing system of any of clauses A through G, wherein the control and monitoring node is further configured to determine a confidence level of an identity of the authenticated user based at least on the information received from the user tracking system, determine a level of access to be provided to the authenticated user based on the confidence level, and generate the security policy such that the network node provides the client with the level of access to the destination node.

I. A computing system, comprising one or more processors, memory, and a plurality of programming instructions stored on the memory and executable by the one or more processors to perform acts comprising receiving, from a user tracking system, information indicating a current association between a user identifier of an authenticated user and a device identifier of a client device associated with the authenticated user, wherein the user tracking system tracks the user and maintains state information regarding whether the user is or has been authenticated; accessing a user-specific security policy that is associated with the user identifier and that indicates at least a network destination and a user-specific security-related action associated with the network destination; generating an active security policy based at least on the user-specific security policy and the information indicating the current association between the user identifier and the device identifier; and providing the active security policy to a network node.

J. The computing system of clause I, wherein the acts further comprise receiving, from another user tracking system, other information regarding a location of the client device associated with the authenticated user, the other information including at least a location of the client device; determining a level of access to be provided to the authenticated user based on the information and the other information; and generating the active security policy such that the network node provides the client with the level of access to the destination node.

K. The computing system of clauses I or J, wherein the network node is the network destination.

L. The computing system of any of clauses I through K, wherein the device identifier includes at least a network address.

M. The computing system of clause L, wherein the user identifier is a first user identifier, the authenticated user is a first authenticated user, and the device identifier is a first device identifier that includes at least non-address information, and wherein the active security policy indicates a second device identifier currently associated with a second user identifier of a second authenticated user, the second device identifier including the network address and second non-address information that is different from the first non-address information of the first device identifier.

N. The computing system of any of clauses I through M, wherein the user tracking system is one or more of a lightweight directory access protocol based directory service or a mobile device manager that authenticates the user associated with the client device.

O. The computing system of any of clauses I through N, wherein the client device is situated behind a network address translation (NAT) device.

P. The computing system of any of clauses I through O, wherein the client device is a shared user system that provides a desktop service to a user device of the user.

Q. A method comprising receiving by a computing system, from a user tracking system, an indication that a user associated with a user identifier has been authenticated; receiving by the computing system, from the user tracking system, a device identifier of a client device currently associated with the user identifier; generating, by the computing system, an active security policy for the user based at least on the device identifier of the client device and a user-specific security policy that indicates at least a destination address and a security action associated with attempts by the user to access the destination address; and providing, by the computing system, the active security policy to a network node that provides security services to a destination computing system associated with the destination address.

R. The method of clause Q, wherein the network node is the destination computing system.

S. The method of claim clause Q or R, wherein the device identifier of the client device includes at least a network address of a shared user system that provides remote desktop services to a user device associated with the user, and the device identifier of the client device further includes protocol port data assigned to a remote desktop service session provided to the user by the shared user system.

T. The method of any of clauses Q through S, wherein the identifier of the client device includes at least a tunnel network address assigned to the client device.

U. A computing system, comprising means for receiving, from a user tracking system, information indicating a current association between a user identifier of an authenticated user and a device identifier of a client device associated with the authenticated user, wherein the user tracking system tracks the user and maintains state information regarding whether the user is or has been authenticated; means for accessing a user-specific security policy that is associated with the user identifier and that indicates at least a network destination and a user-specific security-related action associated with the network destination; means for generating an active security policy based at least on the user-specific security policy and the information indicating the current association between the user identifier and the device identifier; and means providing the active security policy to a network node.

V. The computing system of clause U, further comprising means for receiving, from another user tracking system, other information regarding a location of the client device associated with the authenticated user, the other information including at least a location of the client device; means for determining a level of access to be provided to the authenticated user based on the information and the other information; and means for generating the active security policy such that the network node provides the client with the level of access to the destination node.

W. The computing system of clauses U or V, wherein the network node is the network destination.

X. The computing system of any of clauses U through W, wherein the device identifier includes at least a network address.

Y. The computing system of clause X, wherein the user identifier is a first user identifier, the authenticated user is a first authenticated user, and the device identifier is a first device identifier that includes at least non-address information, and wherein the active security policy indicates a second device identifier currently associated with a second user identifier of a second authenticated user, the second device identifier including the network address and second non-address information that is different from the first non-address information of the first device identifier.

Z. The computing system of any of clauses U through Y, wherein the user tracking system is one or more of a lightweight directory access protocol based directory service or a mobile device manager that authenticates the user associated with the client device.

AA. The computing system of any of clauses U through Z, wherein the client device is situated behind a network address translation (NAT) device.

AB. The computing system of any of clauses U through AA, wherein the client device is a shared user system that provides a desktop service to a user device of the user.

AC. The computing system of any of clauses U through AB, further comprising means for validating identity of the user based at least on first input from at least the user tracking system, and further based on second input from the network node indicating usage data of the user.

AD. The distributed computing system of clause AC, further comprising means for determining a level of access to be provided to the user based at least on the first input from the plurality of user tracking systems, the first input including application node access levels of the user, and means for generating the active security policy such that the network node provides the client with the level of access to the destination node.

AE. The distributed computing system of any of clauses U through AD, further comprising means for determining a confidence level of an identity of the user based at least on the information received from the user tracking system, means for determining a level of access to be provided to the user based on the confidence level, and means for generating the security policy such that the network node provides the client with the level of access to the destination node.

### CONCLUSION

Although the techniques have been described in language specific to structural features and/or methodological acts, it is to be understood that the appended claims are not necessarily limited to the features or acts described. Rather, the features and acts are described as example implementations.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A distributed computing system comprising:
a plurality of processors;
memory; and
a plurality of programming instructions stored on the memory and executable by the plurality of processors to implement:
a user tracking system to authenticate a user accessing one or more networks via a client device and to determine a client device identifier of the client device;
a control and monitoring node to:
receive information indicating a presently valid association between a user identifier of the user and the client device identifier; and
generate an active security policy for the user based at least on the client device identifier and a user-specific security policy that indicates at least a destination node and an action to be applied to attempts by the user to access the destination node; and
a firewall to enforce the active security policy by at least inspecting the data packets and identifying from the data packets attempts by the user to access the destination node.

2. The distributed computing system of claim 1, wherein the client device identifier indicates at least a network address of a shared user system and protocol port information assigned to a shared user system session provided to the user by the shared user system.

3. The distributed computing system of claim 1, wherein the plurality of programming instructions are further executable by the plurality of processors to implement a tunnel endpoint service that provides a tunneling service to the client device, and wherein the client device identifier includes at least an inner IP address assigned to the client device and associated with the tunneling service.

4. The distributed computing system of claim 1, wherein the user tracking system is a lightweight directory access protocol based directory service that authenticates the user associated with the client device, wherein the distributed computing system further comprises another user tracking system that tracks a location of the client device, and the control and monitoring node is further configured to generate the active security policy for the user based at least on the location of the client device.

5. The distributed computing system of claim 1, wherein the control and monitoring node is configured to provide the active security policy to the network node based at least on determining that the network node has been instantiated.

6. The distributed computing system of claim 1, further comprising a plurality of user tracking systems, including the user tracking system, and wherein the control and monitoring node is further configured to validate identity of the authenticated user based at least on first input from the plurality of user tracking systems, and further based on second input from the network node indicating usage data of the authenticated user.

7. The distributed computing system of claim 6, wherein the control and monitoring node is further configured to:
determine a level of access to be provided to the authenticated user based at least on the first input from the plurality of user tracking systems, the first input including application node access levels of the authenticated user; and
generate the active security policy such that the network node provides the client with the level of access to the destination node.

8. The distributed computing system of claim 1, wherein the control and monitoring node is further configured to:
determine a confidence level of an identity of the authenticated user based at least on the information received from the user tracking system;
determine a level of access to be provided to the authenticated user based on the confidence level; and
generate the security policy such that the network node provides the client with the level of access to the destination node.

9. A computing system, comprising:
one or more processors;
memory; and
a plurality of programming instructions stored on the memory and executable by the one or more processors to perform acts comprising:
receiving, from a user tracking system, information indicating a current association between a user identifier of an authenticated user and a device identifier of a client device associated with the authenticated user, wherein the user tracking system tracks the user and maintains state information regarding whether the user is or has been authenticated;
accessing a user-specific security policy that is associated with the user identifier and that indicates at least a network destination and a user-specific security-related action associated with the network destination;
generating an active security policy based at least on the user-specific security policy and the information indicating the current association between the user identifier and the device identifier; and
providing the active security policy to a network node.

10. The computing system of claim 9, wherein the acts further comprise:
receiving, from another user tracking system, other information regarding a location of the client device associated with the authenticated user, the other information including at least a location of the client device;
determining a level of access to be provided to the authenticated user based on the information and the other information; and
generating the active security policy such that the network node provides the client with the level of access to the destination node.

11. The computing system of claim 9, wherein the network node is the network destination.

12. The computing system of claim 9, wherein the device identifier includes at least a network address.

13. The computing system of claim 12, wherein the user identifier is a first user identifier, the authenticated user is a first authenticated user, and the device identifier is a first device identifier that includes at least non-address information, and wherein the active security policy indicates a second device identifier currently associated with a second user identifier of a second authenticated user, the second device identifier including the network address and second non-address information that is different from the first non-address information of the first device identifier.

14. The computing system of claim 9, wherein the user tracking system is one or more of a lightweight directory access protocol based directory service or a mobile device manager that authenticates the user associated with the client device.

15. The computing system of claim 9, wherein the client device is situated behind a network address translation (NAT) device.

16. The computing system of claim 9, wherein the client device is a shared user system that provides a desktop service to a user device of the user.

17. A method comprising:
receiving by a computing system, from a user tracking system, an indication that a user associated with a user identifier has been authenticated;
receiving by the computing system, from the user tracking system, a device identifier of a client device currently associated with the user identifier;
generating, by the computing system, an active security policy for the user based at least on the device identifier of the client device and a user-specific security policy that indicates at least a destination address and a security action associated with attempts by the user to access the destination address; and
providing, by the computing system, the active security policy to a network node that provides security services to a destination computing system associated with the destination address.

18. The method of claim 17, wherein the network node is the destination computing system.

19. The method of claim 17, wherein the device identifier of the client device includes at least a network address of a shared user system that provides remote desktop services to a user device associated with the user, and the device identifier of the client device further includes protocol port data assigned to a remote desktop service session provided to the user by the shared user system.

20. The method of claim 17, wherein the identifier of the client device includes at least a tunnel network address assigned to the client device.
